(19) United States
(12) Patent Application Publication
(10) Pub. No.: US 2012/0081033 A1
(43) Pub. Date: Apr. 5, 2012

(54) WHITE LIGHT EMITTING DIODE

(75) Inventors: Tsung-Ting SUN, Chung-Ho City (TW); Shih-Tai Chuang, Chung-Ho City (TW)

(73) Assignee: EDISON OPTO CORPORATION

(21) Appl. No.: 12/895,910

(22) Filed: Oct. 1, 2010

(51) Int. Cl. H05B 37/02

(52) U.S. Cl. 315/294

(57) ABSTRACT

A white light emitting diode comprises a light emitting diode chip for emitting a blue light, a first wavelength conversion layer and a second wavelength conversion layer. The light emitting diode chip comprises a first lighting area and a second lighting area through which at least two currents flow, respectively. The first wavelength conversion layer is coated on the first lighting area and generates a first conversion light upon excitation by the blue light. A warm white light is generated by mixing the blue light and the first conversion light. The second wavelength conversion layer is coated on the second lighting area and generates a second conversion light upon excitation by the blue light. A cold white light is generated by mixing the blue light and the second conversion light. The amount of the currents can be controlled to modify the luminescence intensity of each light area, thus adjusting the color temperature of the white LED.

### BACKGROUND OF THE INVENTION

1. Field of the Invention

The present invention relates to a white light emitting diode, and more particularly to a white light emitting diode which can be controlled to adjust lights for generating different color temperature.

2. Description of Prior Art

A light emitting diode (LED) is a kind of semiconductor device, which exploits the property of direct-bandgap semiconductor material to convert electric energy into light energy efficiently and has the advantages of long lifetime, high stability and low power consumption. The LED is primarily used for the applications of indication lamp, traffic sign and sign broad; however, the white LED extends to lighting field when white light LED is successfully developed.

The traditional method of manufacturing a white light emitting diode, is to coat a blue light emitting diode chip with yellow phosphor layer comprising Yttrium Aluminum Garnet fluorescent material. The yellow phosphor is excited by the blue light of the blue light emitting diode chip and emits yellow light, the emitted yellow light is mixed with the blue light to generate white light. However, the blue light occupies major portion of the white light spectrum, thus the white light emitting diode having the problems of high color temperature and the non-uniformity in the mixed light.

Moreover, an improved lighting module is proposed to mix the light of white light emitting diodes mentioned above and the light of red light emitting diodes (or green light emitting diodes) to solve the problem of high color temperature. However, the light emitting diodes of different colors are made of different material, thus the circuit design for the white light emitting diode becoming difficult. The chromatic characteristic and the lifetime of each lighting module are different because each light emitting diode also has different temperature characteristic and lifetime. This causes inconvenience for user.

### SUMMARY OF THE INVENTION

In order to solve the above-mentioned problems of traditional white light emitting diode, such as high color temperature, non-uniform mixed light and inconvenience in use, the object of the present invention is to provide a white light emitting diode to generate white lights with different color temperatures, and mix the white lights with different color temperatures to adjust the resulting color temperature of the white light emitting diode.

Therefore, the present invention provides a white light emitting diode. The white light emitting diode comprises a light emitting diode chip, a first wavelength conversion layer and a second wavelength conversion layer.

The light emitting diode chip which emitting blue light comprises a first lighting area and a second lighting area. The first lighting area and the second lighting area are conducted with at least two currents, respectively.

The first wavelength conversion layer is coated on the first lighting area and generates a first conversion light upon excitation by the blue light which emits from the light emitting diode chip. A warm white light is generated by mixing the blue light and the first conversion light.

The second wavelength conversion layer is coated on the second lighting area and generates a second conversion light upon excitation by the blue light which emits from the light emitting diode chip. A cold white light is generated by mixing the blue light and the second conversion light. The amount of the current can be controlled to modify the luminescence intensity of each light area to adjust the color temperature of the white LED.

The white light emitting diode divides the light emitting diode chip into at least two lighting areas and covers different wavelength conversion layers on each lighting area, thus mixing the white lights with different color temperatures to modify the resulting color temperature of the white LED. The white light emitting diode according to the present invention has simple manufacture process and effectively solves the problem of unequal lifetime of different LEDs and the problem of difficult circuit design due to different driving voltages for different LEDs.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a top view of the white light emitting diode according to a first embodiment of the present invention;

FIG. 2 is a cross sectional view of the white light emitting diode according to the first embodiment of the present invention;

FIG. 3 is a top view showing the electrode connecting form of the white light emitting diode according to the present invention;

FIG. 4 is a cross sectional view showing the electrode connecting form of the white light emitting diode according to the present invention;

FIG. 5 is a top view of the white light emitting diode according to a second embodiment of the present invention; and

FIG. 6 is a close up view of a center region of CIE chromaticity diagram of white light emitting diode according to the present invention.

### DETAILED DESCRIPTION OF THE INVENTION

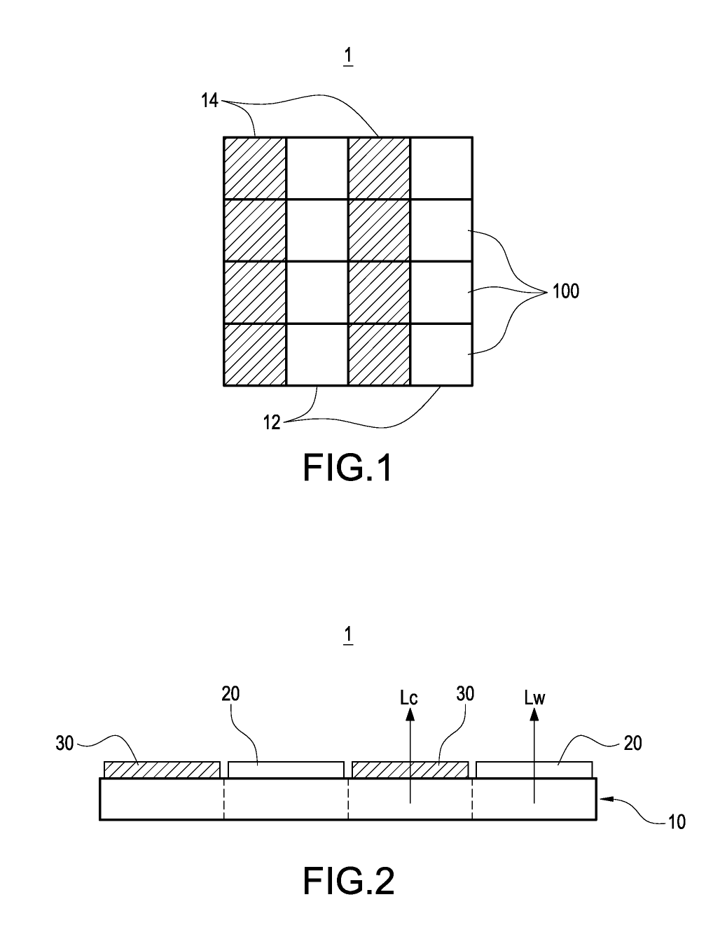

Referring to FIG. 1 and FIG. 2, a top view and a cross sectional view of the white light emitting diode according to a first embodiment of the present invention are shown. The white light emitting diode 1 comprises a blue light emitting diode chip 10, a first wavelength conversion layer 20 and a second wavelength conversion layer 30.

The blue light emitting diode chip 10 emits blue light and comprises a first lighting area 12 and a second lighting area 14. The first lighting area 12 conducts a first current, and the second lighting area 14 conducts a second current. In this embodiment, the blue light emitting diode chip comprises sixteen lighting units 100, which are arranged in accordance with a matrix pattern. The first lighting area 12 and the second lighting area 14 comprise eight lighting units 100 electrically connected in series, respectively. However, in the practical application of the present invention is not limited by the above example.

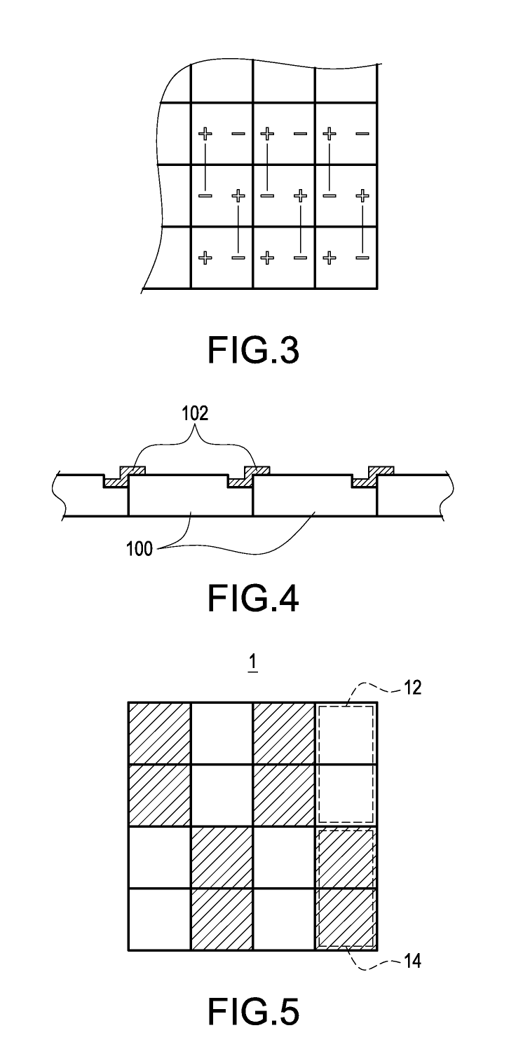

Referring to FIG. 3 and FIG. 4, a top view and a cross sectional view show the electrode connecting form of the white light emitting diode according to the present invention. The first lighting area 12 and the second lighting area 14 comprise a plurality of lighting units 100, respectively. Each of the lighting units 100 is electrically connected in series by the conductive units 102, thus the same current flows through all the lighting units 100.

Referring to FIG. 1 and FIG. 2 again, the first wavelength conversion layer 20 is coated on the first lighting area 12. The first wavelength conversion layer 20 comprises yellow phosphor and red phosphor which converts blue light emitted from the blue light emitting diode chip 10 into light having a longer wavelength. The first wavelength conversion layer 20 generates a first conversion light L1 upon excitation by the blue light which emits from the light emitting diode chip when the first current I1 is conducted to the first area 12. A warm white light Lw is generated by mixing the blue light and the first conversion light L1. In more particularly, the color temperature of the warm white light is in the range between 2670K and 3800K.

The second wavelength conversion layer 30 is coated on the second lighting area 14. The second wavelength conversion layer 30 comprises yellow photoluminescence phosphor. The second wavelength conversion layer 30 generates a second conversion light L2 upon excitation by the blue light when conducted the second current I2 to the second area 14. A cold white light Lc is generated by mixing the blue light which emits from the light emitting diode chip and the second conversion light L2. In more particularly, the color temperature of the cold white light is in the range between 5000K and 10000K.

When the first lighting area 12 and the second lighting area 14 conduct the first current I1 and the second current I2, respectively, a middle area between the first lighting area 12 and the second lighting area 14 emits a light mixture of the warm white light Lw and the cold white light Lc to generated a neutral white light. In more particularly, the color temperature of the neutral white light is in the range from 3800K to 5000K.

Moreover, the luminous flux of the lighting areas 12, 14 is directly proportional to the current flow through the lighting area 12, 14, thus the color temperature of the white light emitting diode 1 can be adjusted by controlling the current flow of the first current I1 and the second current I2 when the number of the lighting units 100 of the first lighting area 12 and the second lighting area 14 are the same. A neutral white light is generated by mixing the warm white light Lw and the cold white light Lc while the first current I1 is equal to the second current I2. The luminous flux of the warm white light Lw is also the same as the luminous flux of the cold white light Lc. A warmer neutral white light is generated by mixing the warm white light Lw and the cold white light Lc while the first current I1 is larger than the second current I2. The luminous flux of the warm white light Lw is also larger than the luminous flux of the cold white light Lc. Thus, a warm white light is generated by the white light emitting diode 1 while the second current I2 is equal to zero. A colder neutral white light is generated by mixing the warm white light Lw and the cold white light Lc while the first current I1 less than the second current I2. The luminous flux of the warm white light Lw is also less than the luminous flux of the cold white light Lc. Thus, a cold white light is generated by the white light emitting diode 1 while the first current I1 is equal to zero.

Referring to the FIG. 5, a top view of the white light emitting diode according to a second embodiment of the present invention is shown. The difference between this embodiment and the first embodiment is that the arrangement of the light area 12, 14 of the blue light emitting diode 10. In this embodiment, the first lighting area 12 and the second lighting area 14 are in staggered arrangement. The first lighting area 12 and the second lighting area 14 are covered with the first wavelength conversion layer 20 and the second wavelength conversion layer 30, respectively. The first lighting area 12 and the second lighting area 14 respective emits warm white light Lw and cold white light Lc while the first current I1 and the second current I2 flow therethrough. A neutral white light is generated by mixing the warm white light Lw and the cold white light Lc. In more particularly, the uniformity of the mixed neutral white light increases due to the staggered arrangement of the first lighting area 12 and the second lighting area 14.

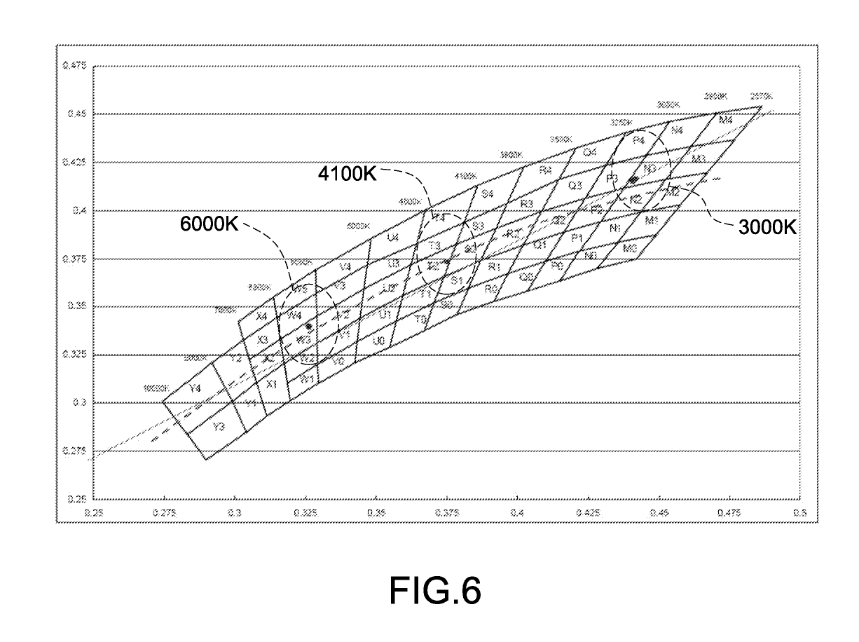

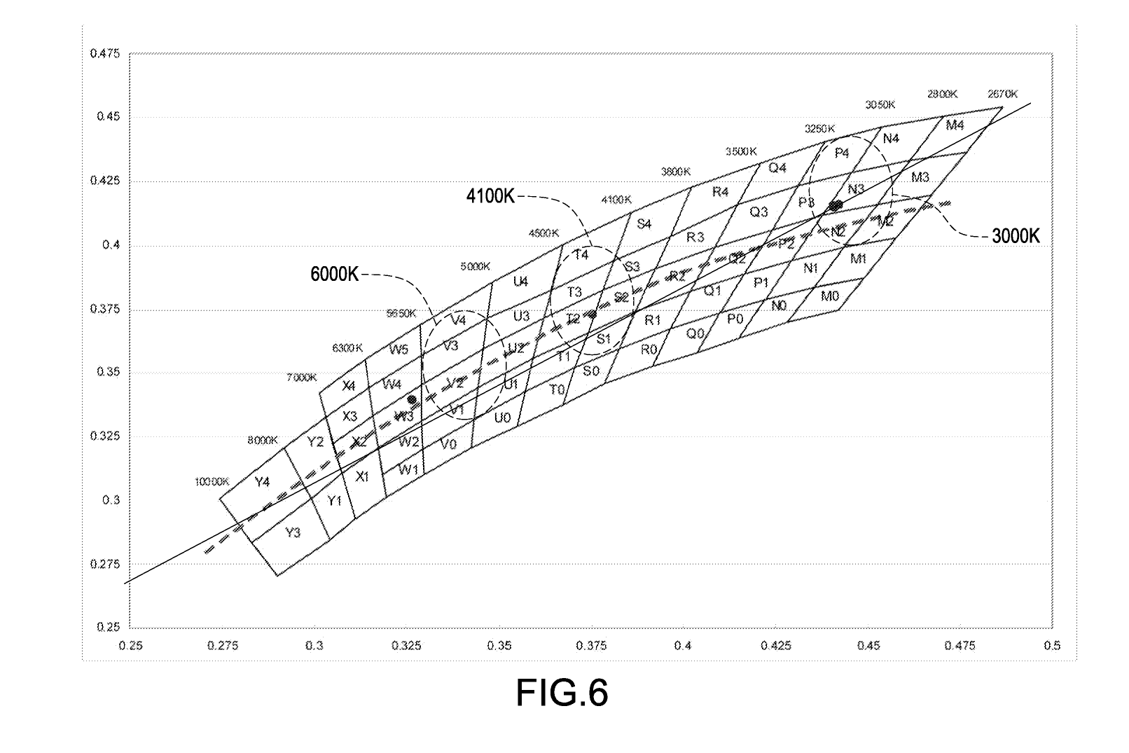

Referring to FIG. 6, a CIE chromaticity diagram is shown to demonstrate the white light emitting diode according to the present invention is shown. It depicts the regions corresponding to color temperatures of 6000K, 4100K and 3000K, which are corresponding to cold white light, neutral white light and warm white light, respectively.

The table below shows test data of the white light emitting diode according to the present invention. The white light emitting diode under a test comprises six lighting units arranged in accordance with a matrix pattern. The first lighting area and the second lighting area comprise three lighting units electrically connected in series, respectively. The first light units and the second lighting units are conducted with the first current and the second current, respectively. The first current is equal to the second current. The CIE coordinates in rows with number 1 to 3 are (0.3263, 0.3397), (0.3266, 0.3394), and (0.3263, 0.3398), which are corresponding to color temperatures of 3012K, 2990K, 2982K, respectively, where those color temperatures indicate cold white light. The CIE coordinates in rows with number 4 to 6 are (0.4404, 0.4160), (0.4410, 0.4150), and (0.4422, 0.4162), which are corresponding to color temperatures of 3012K, 2990K, 2982K, respectively, where those color temperatures indicate warm white light. The row with number 7 in the table is a white light emitting diode consisted of the six light units mentioned above. The white light emitting diode has CIE coordinate (0.3752, 0.3733), which is corresponding to color temperature of 4108K for emitting neutral white light.

| | Coordinate | Coordinate | Corresponding |
|---|---|---|---|
| No. | of X axis | of Y axis | Color Temperature (K) |
| 1 | 0.3263 | 0.3397 | 6021 |
| 2 | 0.3266 | 0.3394 | 5980 |
| 3 | 0.3263 | 0.3398 | 6051 |
| 4 | 0.4404 | 0.4160 | 3012 |
| 5 | 0.4410 | 0.4150 | 2990 |
| 6 | 0.4422 | 0.4162 | 2982 |
| 7 | 0.3752 | 0.3733 | 4108 |

To sum up, the white light emitting diode according to the present invention divides the blue light emitting diode into at least two lighting areas and covers different wavelength conversion layers on each of the lighting areas. At least two currents are conducted to any lighting area which needs to be conducted and the amount of the current is controlled to generate white light with different color temperature at the same time. Moreover, color temperature can be further fine-tuned by mixing the white lights with different color temperatures. The white light emitting diode according to the present invention has simple manufacture process and effectively solves the problem of unequal lifetime of different LEDs and the problem of difficult circuit design due to different driving voltages for different LEDs.

Although the present invention has been described with reference to the foregoing preferred embodiments, it will be understood that the invention is not limited to the detail thereof. Various equivalent variations and modifications can still occur to those skilled in this art in view of the teachings of the present inventions. Thus, all such variations and equivalent modifications are also embraced within the scope of the invention as define in the appended claims.

What is claimed is:

1. A white light emitting diode comprising:
a light emitting diode chip including a first lighting area and a second lighting area the light emitting diode chip emitting a blue light and comprising a first lighting area and a second lighting area conducting at least two currents, respectively;
a first wavelength conversion layer coated on the first lighting area and generating a first conversion light upon excitation by the blue light, wherein a warm white light is generated by mixing the blue light and the first conversion light; and
a second wavelength conversion layer coated on the second lighting area and generating a second conversion light upon excitation by the blue light, wherein a cold white light is generated by mixing the blue light and the second conversion light;
wherein the amount of the currents are controlled to adjust the luminescence intensity of each light area, thus modifying the color temperature of the white light emitting diode.

2. The white light emitting diode of claim 1, wherein the currents includes a first current and a second current.

3. The white light emitting diode of claim 1, wherein the first wavelength conversion layer comprises a yellow phosphor and red phosphor.

4. The white light emitting diode of claim 1, wherein the second wavelength conversion layer comprises yellow phosphor.

5. The white light emitting diode of claim 1, wherein the first lighting area and the second lighting area comprise a plurality of lighting units, respectively.

6. The white light emitting diode of claim 5, wherein the number of lighting units of the first lighting area and the second light area are the same.

7. The white light emitting diode of claim 6, wherein the white light emitting diode emits neutral white light when the first current is equal to the second current.

8. The white light emitting diode of claim 5, wherein the lighting units are electrically connected in series.

9. The white light emitting diode of claim 5, wherein the lighting units are arranged in a matrix pattern.

10. The white light emitting diode of claim 5, wherein the lighting units are formed in staggered arrangement.
